(19) United States
(12) Patent Application Publication
(10) Pub. No.: US 2019/0250591 A1
(43) Pub. Date: Aug. 15, 2019

(54) MANAGEMENT DEVICE, MANAGEMENT PROGRAM, AND MANAGEMENT METHOD

(71) Applicant: SUMITOMO ELECTRIC INDUSTRIES, LTD., Osaka-shi, Osaka (JP)

(72) Inventors: Takashi YAMAMOTO, Osaka-shi, Osaka (JP); Hideo AKIMOTO, Osaka-shi, Osaka (JP)

(73) Assignee: SUMITOMO ELECTRIC INDUSTRIES, LTD., Osaka-shi, Osaka (JP)

(21) Appl. No.: 16/319,863

(22) PCT Filed: Jul. 5, 2017
(86) PCT No.: PCT/JP2017/024667

§ 371 Date: Jan. 23, 2019

(30) Foreign Application Priority Data
Aug. 8, 2016 (JP) 2016-155560

(51) Int. Cl. G05B 19/4155; G05B 19/406

(52) U.S. Cl. CPC G05B 19/4155; G05B 2219/45135; G05B 19/406

(57) ABSTRACT

Provided is a management device including: a first acquisition unit configured to acquire a measurement result of a sensor which performs measurement regarding an apparatus, and a time corresponding to the measurement result; a second acquisition unit configured to acquire, from a storage unit, a plurality of use periods of the apparatus, and contents of a management item corresponding to the respective use periods; and a data processing unit configured to perform a process of aggregating, for each of the contents, measurement information based on the measurement result, on the basis of the measurement result and the corresponding time acquired by the first acquisition unit, and the contents and the corresponding use periods obtained by the second acquisition unit.

### TECHNICAL FIELD

The present invention relates to a management device, a management program, and a management method.

This application claims priority on Japanese Patent Application No. 2016-155560 filed on Aug. 8, 2016, the entire contents of which are incorporated herein by reference.

### BACKGROUND ART

For example, Patent Literature 1 (Japanese Laid-Open Patent Publication No. 2016-38709) discloses a technology as follows. That is, a welding system includes: a welding device which feeds a welding wire to a welding torch to perform welding; a welding data recording device which is contained in the welding device and records welding data regarding a welding operation of the welding device; and a welding data management device which collects and processes the welding data recorded by the welding data recording device of the welding device. The welding data recording device includes: an amount-of-used-wire detector which detects the amount of wire fed to the welding torch; a current detector which detects a welding current of the welding device; and a wireless transmitter which wirelessly transmits the welding data recorded by the welding data recording device, to the welding data management device. The welding data management device includes: a data collection unit which collects the welding data regarding the welding device and transmitted from the wireless transmitter; and a data processing unit which processes the collected data.

### CITATION LIST

### Patent Literature

PATENT LITERATURE 1: Japanese Laid-Open Patent Publication No. 2016-38709

### SUMMARY OF INVENTION

(1) A management device according to the present disclosure includes: a first acquisition unit configured to acquire a measurement result of a sensor which performs measurement regarding an apparatus, and a time corresponding to the measurement result; a second acquisition unit configured to acquire, from a storage unit, a plurality of use periods of the apparatus, and contents of a management item corresponding to the respective use periods; and a data processing unit configured to perform a process of aggregating, for each of the contents, measurement information based on the measurement result, on the basis of the measurement result and the corresponding time acquired by the first acquisition unit and the contents and the corresponding use periods acquired by the second acquisition unit.

(7) A management program according to the present disclosure is a management program used in a management device, and the management program causes a computer to function as: a first acquisition unit configured to acquire a measurement result of a sensor which performs measurement regarding an apparatus, and a time corresponding to the measurement result; a second acquisition unit configured to acquire, from a storage unit, a plurality of use periods of the apparatus, and contents of a management item corresponding to the respective use periods; and a data processing unit configured to perform a process of aggregating, for each of the contents, measurement information based on the measurement result, on the basis of the measurement result and the corresponding time acquired by the first acquisition unit and the contents and the corresponding use periods acquired by the second acquisition unit.

(8) A management method according to the present disclosure is a management method for a management device, and the management method includes the steps of: acquiring a measurement result of a sensor which performs measurement regarding an apparatus, and a time corresponding to the measurement result; acquiring, from a storage unit, a plurality of use periods of the apparatus, and contents of a management item corresponding to the respective use periods; and performing a process of aggregating, for each of the contents, measurement information based on the measurement result, on the basis of the acquired measurement result and the corresponding time and the acquired contents and the corresponding use periods.

One aspect of the present disclosure can be implemented not only as a management device including such a characteristic processing unit but also as a management system including the management device. Meanwhile, one aspect of the present disclosure can be implemented as a semiconductor integrated circuit that implements a part or the entirety of the management device.

### BRIEF DESCRIPTION OF DRAWINGS

FIG. 1 illustrates a configuration of a management system according to a first embodiment of the present invention.

FIG. 2 illustrates an example of sensor data stored in a storage device in the management system according to the first embodiment of the present invention.

FIG. 3 illustrates an example of sensor data stored in the storage device in the management system according to the first embodiment of the present invention.

FIG. 4 illustrates an example of report data retained by a terminal device in the management system according to the first embodiment of the present invention.

FIG. 5 illustrates an example of report data retained by the terminal device in the management system according to the first embodiment of the present invention.

FIG. 6 illustrates a configuration of a management device according to the first embodiment of the present invention.

FIG. 7 illustrates an example of a summary table created by the management device according to the first embodiment of the present invention.

FIG. 8 illustrates an example of a summary table created by the management device according to the first embodiment of the present invention.

FIG. 9 illustrates an example of report data retained by the terminal device in the management system according to the first embodiment of the present invention.

FIG. 10 illustrates an example of report data retained by the terminal device in the management system according to the first embodiment of the present invention.

FIG. 11 illustrates an example of a summary table created by the management device according to the first embodiment of the present invention.

FIG. 12 illustrates an example of report data retained by the terminal device in the management system according to the first embodiment of the present invention.

FIG. 13 illustrates an example of a summary table created by the management device according to the first embodiment of the present invention.

FIG. 14 is a flowchart illustrating an operation procedure when the management device according to the first embodiment of the present invention performs a process of aggregating measurement information for each of contents of a management item.

FIG. 15 illustrates a configuration of a management device according to a second embodiment of the present invention.

### DESCRIPTION OF EMBODIMENTS

To date, management devices for managing the use states of apparatuses have been developed.

### Technical Problem

A system has been studied in which production data is collected through a recording device provided in an apparatus, and workloads of operators, production costs, etc., are calculated based on the collected production data, by using the welding system disclosed in Patent Literature 1, for example.

However, under a situation where an operator who handles the apparatus is replaced with another operator, or the production content of the apparatus is changed, it is difficult to calculate, based on the production data, the workloads by operator and the production costs by production content.

The present disclosure has been made to solve the above problems, and it is an object of the present disclosure to provide a management device, a management program, and a management method which are capable of managing an apparatus through a simple process.

### Advantageous Effects of Invention

According to the present disclosure, it is possible to manage an apparatus through a simple process.

### Description of Embodiments

First, contents of embodiments of the present disclosure will be listed for description.

(1) A management device according to an embodiment of the present disclosure includes: a first acquisition unit configured to acquire a measurement result of a sensor which performs measurement regarding an apparatus, and a time corresponding to the measurement result; a second acquisition unit configured to acquire, from a storage unit, a plurality of use periods of the apparatus, and contents of a management item corresponding to the respective use periods; and a data processing unit configured to perform a process of aggregating, for each of the contents, measurement information based on the measurement result, on the basis of the measurement result and the corresponding time acquired by the first acquisition unit and the contents and the corresponding use periods acquired by the second acquisition unit.

According to this configuration, by using, for example, “operator” or “production content” as the content of the management item, even when an operator handling the apparatus is replaced with another operator, or the production content of the apparatus is changed, it is possible to aggregate the working time based on the measurement result, for each operator or for each production content. Thus, it is possible to easily calculate workloads by operator and production costs by production content, for example. Consequently, it is possible to manage the apparatus through a simple process.

(2) Preferably, the first acquisition unit further acquires first identification information which is identification information of the sensor corresponding to the measurement result, the second acquisition unit further acquires, from the storage unit, second identification information which is identification information of the sensor corresponding to the use periods, and the data processing unit performs the process of aggregating the measurement information for each of the contents, further based on the first identification information acquired by the first acquisition unit and the second identification information acquired by the second acquisition unit.

According to this configuration, even when an operator works at a plurality of apparatuses or produces an object by using a plurality of apparatuses, since the measurement result and the corresponding time can be associated with the content of the management item and the corresponding use period, based on the first identification information and the second identification information, it is possible to correctly calculate, for example, workloads by operator and production costs by production content.

(3) Preferably, settings of the type of the management item are changeable.

According to this configuration, even when a plurality of managers have different types of management items as management targets, since a single management device is capable of performing processes that satisfy the requirements of the respective managers, it is possible to efficiently operate the management device.

(4) Preferably, a plurality of types of management items are settable.

According to this configuration, since the contents of the plurality of types of management items can be associated with each other, it is possible to precisely manage the apparatus.

(5) Preferably, the data processing unit performs a process of aggregating the measurement information for each of the contents and for each of other pieces of information.

According to this configuration, the processing result, which has been obtained by aggregating the measurement information for each of the contents of the management item, is further aggregated for each of other pieces of information. For example, when the measurement result correlates with weather, it is possible to precisely manage the apparatus by adopting weather as the other piece of information.

(6) Preferably, the management device further includes a display control unit configured to perform a control for displaying a result of the process performed by the data processing unit.

According to this configuration, a user of the management device can recognize the processing result from the display content, and therefore can manage the apparatus more easily.

(7) A management program according to an embodiment of the present disclosure is a management program used in a management device, and the management program causes a computer to function as: a first acquisition unit configured to acquire a measurement result of a sensor which performs measurement regarding an apparatus, and a time corresponding to the measurement result; a second acquisition unit configured to acquire, from a storage unit, a plurality of use periods of the apparatus, and contents of a management item corresponding to the respective use periods; and a data processing unit configured to perform a process of aggregating, for each of the contents, measurement information based on the measurement result, on the basis of the measurement result and the corresponding time acquired by the first acquisition unit and the contents and the corresponding use periods acquired by the second acquisition unit.

According to this configuration, by using, for example, “operator” or “production content” as the content of the management item, even when an operator handling the apparatus is replaced with another operator, or the production content of the apparatus is changed, it is possible to aggregate the working time based on the measurement result, for each operator or for each production content. Thus, it is possible to easily calculate workloads by operator and production costs by production content, for example. Consequently, it is possible to manage the apparatus through a simple process.

(8) A management method according to an embodiment of the present disclosure is a management method for a management device, and the management method includes the steps of: acquiring a measurement result of a sensor which performs measurement regarding an apparatus, and a time corresponding to the measurement result; acquiring, from a storage unit, a plurality of use periods of the apparatus, and contents of a management item corresponding to the respective use periods; and performing a process of aggregating, for each of the contents, measurement information based on the measurement result, on the basis of the acquired measurement result and the corresponding time and the acquired contents and the corresponding use periods.

According to this method, by using, for example, “operator” or “production content” as the content of the management item, even when an operator handling the apparatus is replaced with another operator, or the production content of the apparatus is changed, it is possible to aggregate the working time based on the measurement result, for each operator or for each production content. Thus, it is possible to easily calculate workloads by operator and production costs by production content, for example. Consequently, it is possible to manage the apparatus through a simple process.

Hereinafter, embodiments of the present disclosure will be described with reference to the drawings. In the drawings, the same or corresponding parts are denoted by the same reference numerals, and will not be repeatedly described. In addition, at least parts of the embodiments described below may be combined as desired.

### First Embodiment

### [Configuration and Basic Operation]

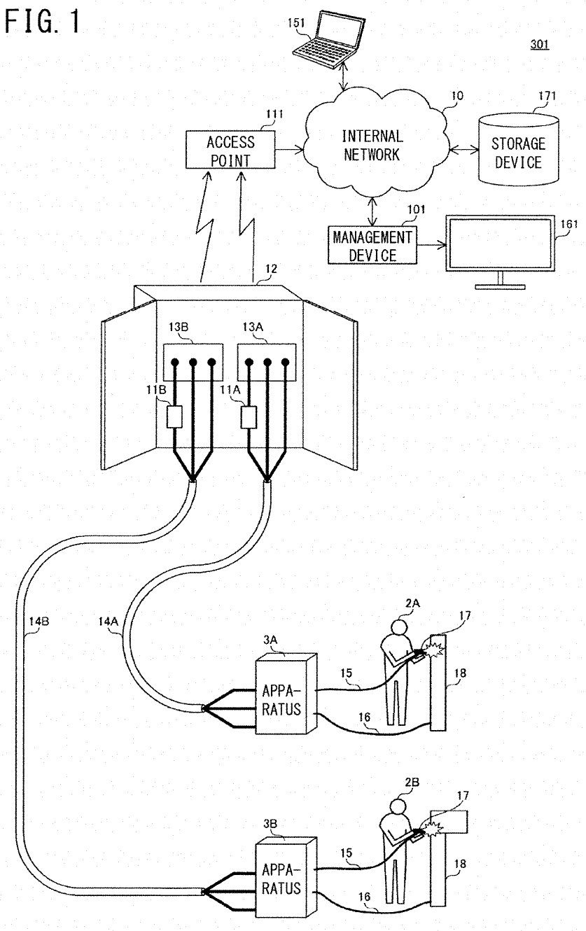

FIG. 1 illustrates a configuration of a management system according to a first embodiment of the present disclosure.

With reference to FIG. 1, a management system 301 includes two sensors 11, an access point 111, a management device 101, a terminal device (storage unit) 151, and a storage device 171.

In this example, apparatuses 3A, 3B are provided in the management system 301. Hereinafter, each of the apparatuses 3A and 3B is also referred to as an apparatus 3. In the management system 301, three or more apparatuses 3 may be provided.

A sensor 11 is provided so as to correspond to an apparatus 3. In this example, sensors 11A, 11B, i.e., the sensors 11, are provided so as to correspond to the apparatuses 3A, 3B, respectively.

The management system 301 includes the two sensors 11, but may include three or more sensors 11.

Each apparatus 3 is an electric welding machine which is operated by using a three-phase AC power supply, for example. The apparatus 3 may be an apparatus other than an electric welding machine.

The apparatuses 3A, 3B are supplied with power from a distribution board 12 via power lines 14A, 14B, respectively. Hereinafter, each of the power lines 14A and 14B is also referred to as a power line 14.

More specifically, the power line 14A contains, for example, three conductive wires for transmitting a three-phase AC current, and has a first end connected to a breaker 13A of the distribution board 12, and a second end connected to the apparatus 3A. Meanwhile, the power line 14B contains, for example, three conductive wires for transmitting a three-phase AC current, and has a first end connected to a breaker 13B of the distribution board 12, and a second end connected to the apparatus 3B.

For example, a sensor 11A is provided to one of the three conductive wires of the power line 14A, on the first end side of the power line 14A. Likewise, a sensor 11B is provided to one of the three conductive wires of the power line 14B, on the first end side of the power line 14B.

Each sensor 11 performs measurement regarding the corresponding apparatus 3, and transmits a radio signal including information that indicates the measurement result. More specifically, the sensor 11 includes, for example, a clamp-type current sensor and a wireless communication unit, and measures a current that flows in the corresponding apparatus 3.

Specifically, the sensor 11A measures a current that flows through the conductive wire, of the power line 14A, to which the sensor 11A is provided, at predetermined intervals, e.g., 10-sec intervals. Meanwhile, the sensor 11B measures a current that flows through the conductive wire, of the power line 14B, to which the sensor 11B is provided, at predetermined intervals, e.g., 10-sec intervals.

Upon completion of measurement, for example, each of the sensors 11A, 11B creates a measurement packet including a sensor ID as its own ID and the measured current value as the measurement result, and transmits a radio signal including the created measurement packet to the access point 111.

Although the sensor 11 is configured to transmit the measurement packet through wireless communication, the sensor 11 may be configured to transmit the measurement packet through wired communication.

Upon receiving the radio signal including the measurement packet from each sensor 11, the access point 111 acquires the measurement packet included in the received radio signal, and transmits the acquired measurement packet to the storage device 171 via an internal network 10 through wired communication.

Each of operators 2A, 2B (also referred to as operators 2) performs welding work on a work object 18 by using the apparatus 3. For example, the work object 18, on which the welding work by the operator 2 is completed, is a product obtained by the use of the apparatus 3.

By using the power received from the distribution board 12 via the power line 14, the apparatus 3 outputs a current via an output line 15 to a torch 17 held by the operator 2. The operator 2 performs the welding work by arc discharge that occurs between the torch 17 and the work object 18. This current returns to the apparatus 3 through the work object 18 and an earth wire 16.

Although the sensor 11 is provided to the power line 14, the sensor 11 may be provided to the output line 15. Although the sensor 11 is provided at the first end side of the power line 14, the sensor 11 may be provided at any position on the power line 14. Furthermore, although the sensor 11 is provided to one of the three conductive wires of the power line 14, sensors 11 may be provided to the three conductive wires or two of the three conductive wires.

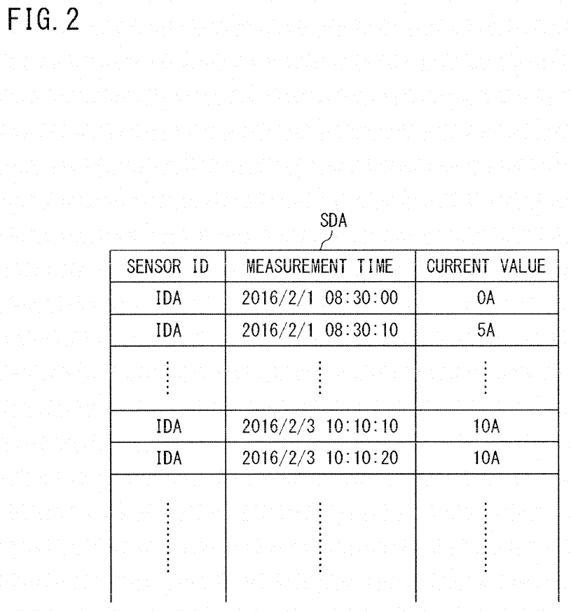

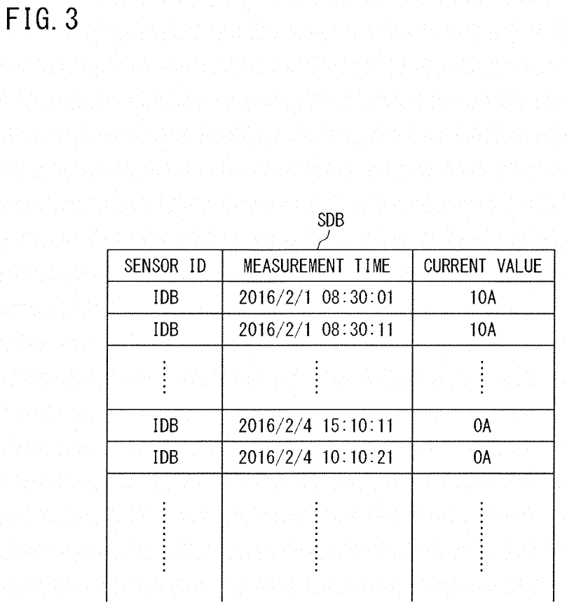

FIG. 2 and FIG. 3 illustrate examples of sensor data stored in the storage device in the management system according to the first embodiment of the present disclosure. FIG. 2 illustrates sensor data SDA including: identification information of the sensor 11A, i.e., “sensor ID”, the measurement result of the sensor 11A, i.e., “current value”; and the corresponding “measurement time”, in chronological order. FIG. 3 illustrates sensor data SDB including: identification information of the sensor 11B, i.e., “sensor ID”; the measurement result of the sensor 11B, i.e., “current value”; and the corresponding “measurement time”, in chronological order.

With reference to FIG. 2 and FIG. 3, the storage device 171 stores therein the sensor data for each sensor 11. In this example, the storage device 171 stores therein the sensor data SDA, SDB corresponding to the sensors 11A, 11B, respectively.

In the storage device 171, the measurement result of each sensor 11 is accumulated. More specifically, upon receiving a measurement packet from the sensor 11 via the access point 111 and the internal network 10, the storage device 171 acquires the sensor ID and the measurement result from the received measurement packet, and acquires, as the measurement time, timing at which the measurement packet has been received.

When the sensor ID is IDA, for example, the storage device 171 adds the sensor ID, the measurement time, and the measurement result (i.e., the current value) to the sensor data SDA. On the other hand, when the sensor ID is IDB, for example, the storage device 171 adds the sensor ID, the measurement time, and the measurement result to the sensor data SDB.

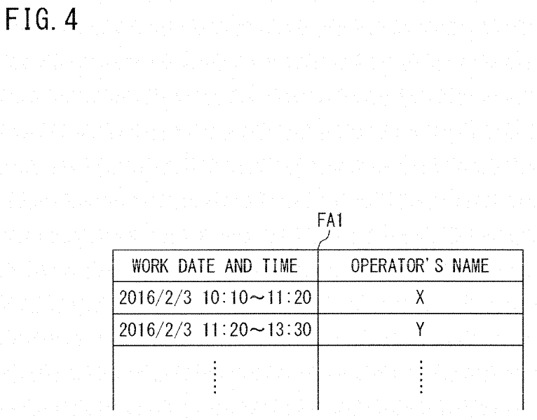

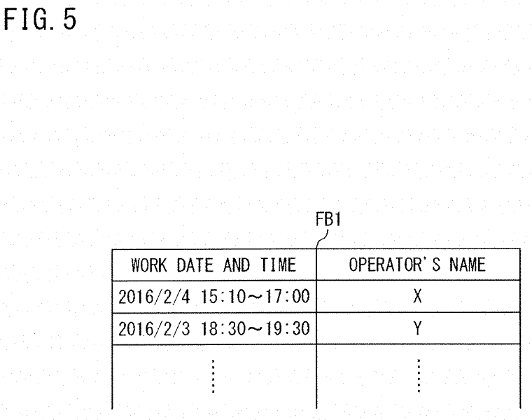

FIG. 4 and FIG. 5 illustrate examples of report data retained by the terminal device in the management system according to the first embodiment of the present disclosure.

With reference to FIG. 4 and FIG. 5, for example, the terminal device 151 has a storage unit, and retains the report data for each apparatus 3 in the storage unit. In this example, the terminal device 151 retains report data FA1, FB1 corresponding to the apparatuses 3A, 3B, respectively.

Each report data contains a plurality of use periods of the corresponding apparatus 3, and the content of a management item corresponding to each use period.

The report data FA1 shown in FIG. 4 contains, for example, “work date and time” indicating the use period of the apparatus 3A, and “operator's name” who performed the work using the apparatus 3A during the corresponding use period. The report data FB1 shown in FIG. 5 contains, for example, “work date and time” indicating the use period of the apparatus 3B, and “operator's name” who performed the work using the apparatus 3B during the corresponding use period.

Examples of the report data include a data file of spreadsheet software, a CSV (Comma-Separated Values) text file, a database, etc.

Upon finishing the work performed with the apparatus 3, the operator 2 performs an operation of inputting, through the terminal device 151, the work date and time and his/her name into the report data corresponding to the apparatus 3.

Specifically, upon finishing the work performed with the apparatus 3A during a period from 10:10 to 11:20 on Feb. 3, 2016, for example, the operator 2A performs, through the terminal device 151, an operation of writing “2016, Feb. 3, 10:10 to 11:20” as the work date and time and “X” as his/her name into the report data FA1, as the use period and the content of the corresponding management item, respectively.

The work date and time is not necessarily represented in units of minutes, but may be represented in units of seconds, hours, days, weeks, or months.

Upon receiving the operation performed by the operator 2A, the terminal device 151 performs a process of writing the content of the operation into the report data FA1.

The operators 2A, 2B each perform the aforementioned operation every time he/she has finished the work using the apparatus 3. Thus, the report data FA1, FB1 are updated.

The terminal device 151 retains correspondence information indicating the correspondence between the sensor ID and the report data. In this example, the correspondence information indicates the correspondence between the report data FA1 and IDA as the sensor ID, and the correspondence between the report data FB 1 and IDB as the sensor ID.

Specifically, as for the correspondence information, the corresponding sensor ID may be included in the file name of the report data, or the corresponding sensor ID may be written in the file of the corresponding report data. Alternatively, the correspondence information may be a file in which the correspondence is written.

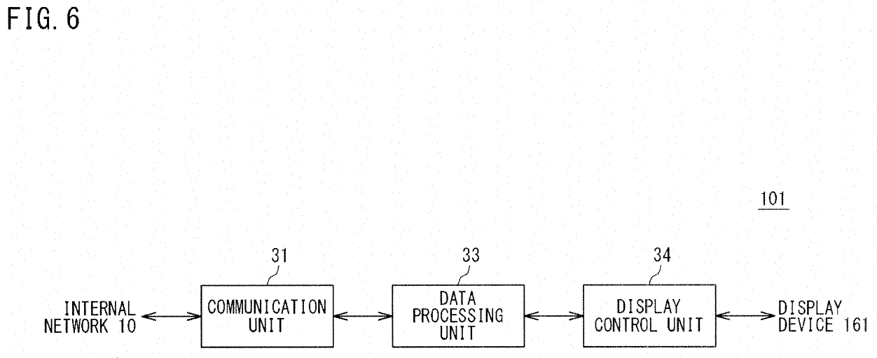

FIG. 6 illustrates a configuration of a management device according to the first embodiment of the present disclosure.

With reference to FIG. 6, the management device 101 includes a communication unit (first acquisition unit and second acquisition unit) 31, a data processing unit 33, and a display control unit 34.

The communication unit 31 transmits/receives information to/from the storage device 171 and the terminal device 151 via the internal network 10.

The communication unit 31 acquires a measurement result of the sensor 11 which performs measurement regarding the apparatus 3, and a time corresponding to the measurement result.

More specifically, the communication unit 31 acquires, for example, the measurement result, the time corresponding to the measurement result, and the identification information of the sensor 11 corresponding to the measurement result.

Specifically, when a predetermined condition C1 is satisfied, the data processing unit 33 transmits a sensor data request, which includes IDA, IDB registered by, for example, a manager, to the storage device 171 via the communication unit 31. For example, the predetermined condition C1 could be that predetermined periodical acquisition timing has arrived.

Upon receiving the sensor data request from the management device 101, the storage device 171 checks IDA, IDB contained in the sensor data request, and transmits the sensor data SDA, SDB corresponding to IDA, IDB, respectively, to the management device 101, in response to the received sensor data request.

Upon receiving the sensor data SDA, SDB from the storage device 171, the communication unit 31 outputs the received sensor data SDA, SDB to the data processing unit 33.

Furthermore, the communication unit 31 acquires, from the terminal device 151, a plurality of use periods of the apparatus 3, and the content of the management item corresponding to each use period. The communication unit 31 further acquires, from the terminal device 151, the identification information of the sensor 11 corresponding to the use period.

Specifically, in response to reception of the sensor data SDA, SDB from the communication unit 31, the data processing unit 33 transmits a correspondence information request for requesting correspondence information to the terminal device 151 via the communication unit 31.

Upon receiving the correspondence information request from the management device 101, the terminal device 151 transmits the correspondence information to the terminal device 151 in response to the received correspondence information request.

Upon receiving the correspondence information from the terminal device 151, the communication unit 31 outputs the received correspondence information to the data processing unit 33.

Upon receiving the correspondence information from the communication unit 31, the data processing unit 33 recognizes, based on the received correspondence information, that the report data corresponding to IDA, IDB are the report data FA1, FB1, respectively, and transmits a report data request R1 for requesting the report data FA1, FB1 to the terminal device 151 via the communication unit 31.

Upon receiving the report data request R1 from the management device 101, the terminal device 151 transmits the report data FA1, FB1 to the terminal device 151 in response to the received report data request R1.

Upon receiving the report data FA1, FB1 from the terminal device 151, the communication unit 31 outputs the received report data FA1, FB1 to the data processing unit 33.

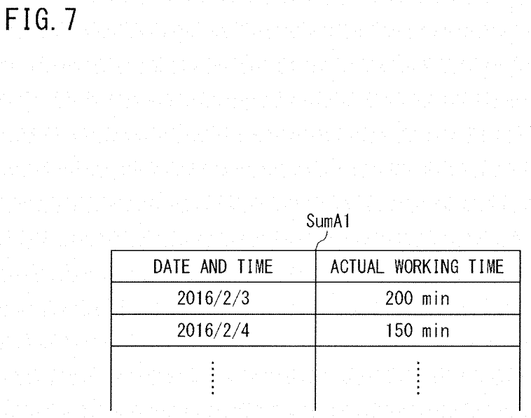

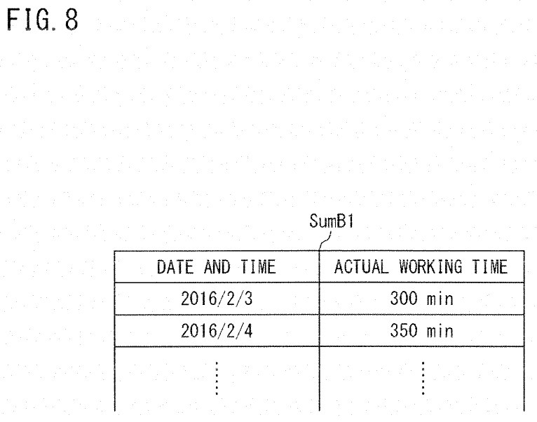

FIG. 7 and FIG. 8 illustrate examples of summary tables created by the management device according to the first embodiment of the present disclosure.

With reference to FIG. 7 and FIG. 8, the data processing unit 33 performs a process of aggregating the measurement information based on the measurement result for each content of the management item, on the basis of the measurement result of the sensor 11 and the time corresponding to the measurement result, and the content of the management item and the corresponding use period.

Specifically, for example, the data processing unit 33 aggregates, in other words, sorts, the measurement information for each content of the management item and for each day, based on the measurement result of the sensor 11, the time corresponding to the measurement result, the sensor ID corresponding to the measurement result, the content of the management item, the use period corresponding to the content, and the sensor ID corresponding to the use period, for example.

Specifically, the data processing unit 33 totals up the actual working time for each operator's name and for each day, based on the sensor data SDA, SDB, the correspondence information, and the report data FA1, FB1.

More specifically, the data processing unit 33 performs the totaling process while associating the sensor ID with the work date and time for each operator, based on the report data FA1, FB1.

Specifically, as for the operator 2A having the operator's name of “X”, the data processing unit 33 associates IDA with “2016, Feb. 3, 10:10 to 11:20” as the work date and time, and associates IDB with “2016, Feb. 4, 15:10 to 17:00” as the work date and time (refer to FIG. 4 and FIG. 5). Also for the operator 2B having the operator's name of “Y”, the data processing unit 33 performs the same process as that for the operator 2A.

The data processing unit 33 totals up the actual working time of the operator 2A, based on the sensor data SDA, SDB.

Specifically, the data processing unit 33 calculates the actual working time, based on the current values which are included in the sensor data SDA (refer to FIG. 2) corresponding to IDA and which have been measured at the measurement times included in the corresponding work date and time such as “2016, Feb. 3, 10:10 to 11:20”.

More specifically, the data processing unit 33 subjects the current values at the respective measurement times to an interpolation process such as zero-order interpolation or linear interpolation, thereby generating a current waveform that approximately indicates temporal change of the current during the work date and time. Then, the data processing unit 33 accumulates time periods during which the current exceeds a predetermined threshold value Th1 in the generated current waveform, thereby calculating the actual working time.

Likewise, the data processing unit 33 calculates the actual working time, based on the current values which are included in the sensor data SDB (refer to FIG. 3) corresponding to IDB and which have been measured at the measurement times included in the corresponding work date and time such as “2016, Feb. 4, 15:10 to 17:00”.

The data processing unit 33, for example, totals up the calculated actual working time for each day, and writes the totaled actual working time into a summary table SumA1 shown in FIG. 7. Also for the operator 2B, the data processing unit 33 performs the same process as that for the operator 2A, and writes the actual working time totaled for each day, into a summary table SumB1 shown in FIG. 8.

The data processing unit 33 notifies the display control unit 34 of the contents of the summary tables SumA1, SumB1.

The display control unit 34 performs control to display the result of the process performed by the data processing unit 33. More specifically, the display control unit 34 controls a display device 161 to display the content of the notification received from the data processing unit 33.

Although the data processing unit 33 is configured to total up the actual working time for each operator's name and for each day, the present disclosure is not limited thereto. The data processing unit 33 may be configured to total up the actual working time for each hour, week, month, or year.

Although the data processing unit 33 is configured to total up the actual working time, the present disclosure is not limited thereto. The data processing unit 33 may be configured to total up the non-working time during which no welding work is performed.

For example, by comparing the non-working time of each operator's name with a planned value, it is possible to know progress of the work, and evaluate propriety of the plan.

### (Modification 1)

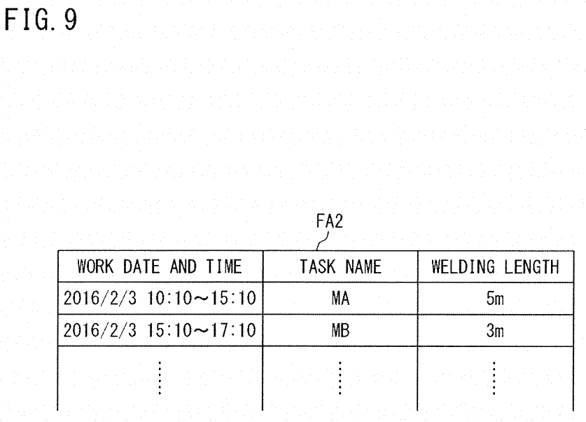

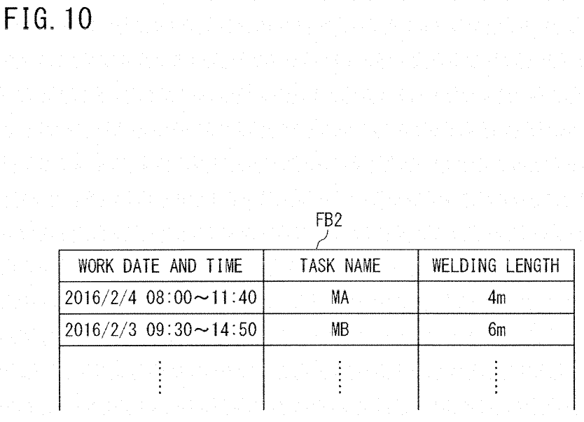

FIG. 9 and FIG. 10 illustrate examples of report data retained by the terminal device in the management system according to the first embodiment of the present disclosure.

With reference to FIG. 9 and FIG. 10, in these examples, the terminal device 151 retains report data FA2, FB2 corresponding to the apparatuses 3A, 3B, respectively.

As for the management item, multiple types of management items can be set. Specifically, the report data FA2 shown in FIG. 9 includes, for example, “work date and time” indicating use periods of the apparatus 3A, “task name” of work during each use period, and “welding length” indicating the result of welding with the apparatus 3A during the use period. The report data FB2 shown in FIG. 10 includes, for example, “work date and time” indicating use periods of the apparatus 3B, “task name” of work during each use period, and “welding length” indicating the result of welding with the apparatus 3B during the use period.

Upon finishing the work using the apparatus 3, for example, the operator 2 performs, through the terminal device 151, an operation of inputting the work date and time, the task name, and the welding length into the report data corresponding to the apparatus 3.

Upon receiving the operation performed by the operator 2, the terminal device 151 performs a process of writing the content of the operation into the report data.

Referring back to FIG. 6, when the predetermined condition C1 is satisfied, the data processing unit 33 transmits a sensor data request to the storage device 171 via the communication unit 31, and receives, as a response to the sensor data request, the sensor data SDA, SDB from the storage device 171 via the communication unit 31.

In response to reception of the sensor data SDA, SDB, the data processing unit 33 transmits a correspondence information request to the terminal device 151 via the communication unit 31, and receives, as a response to the correspondence information request, correspondence information from the terminal device 151 via the communication unit 31.

Upon receiving the correspondence information, the data processing unit 33 recognizes, from the received correspondence information, that the report data corresponding to IDA, IDB are the report data FA2, FB2, respectively, and transmits a report data request R2 for requesting the report data FA2, FB2, to the terminal device 151 via the communication unit 31.

As a response to the report data request R2, the data processing unit 33 receives the report data FA2, FB2 from the terminal device 151 via the communication unit 31.

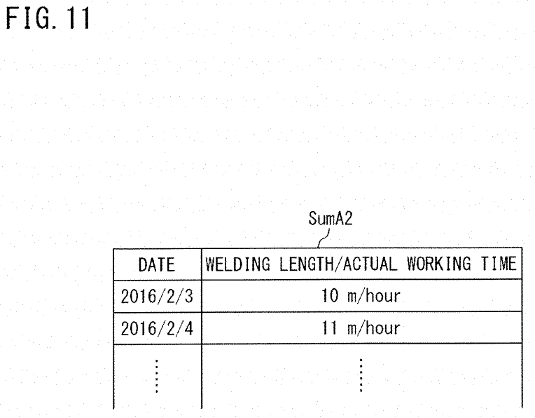

FIG. 11 illustrates an example of a summary table created by the management device according to the first embodiment of the present disclosure.

With reference to FIG. 11, the data processing unit 33 totals up the welding length and the actual working time for each task name and for each day, based on the sensor data SDA, SDB, the correspondence information, and the report data FA2, FB2.

More specifically, the data processing unit 33 performs the totaling process while associating the work date and time and the welding length with the sensor ID, for each task name, based on the report data FA2, FB2.

Specifically, as for a task name MA, the data processing unit 33 associates IDA with “2016, Feb. 3, 10:10 to 15:10” as the work date and time and with “5 m” as the welding length, and associates IDB with “2016, Feb. 4, 08:00 to 11:40” as the work date and time and with “4 m” as the welding length (refer to FIG. 9 and FIG. 10). For a task name MB, the data processing unit 33 performs the same process as that for the task name MA.

The data processing unit 33 totals up the actual working time regarding the task name MA, based on the sensor data SDA, SDB.

Specifically, the data processing unit 33 accumulates time periods, during which a current exceeding the threshold Th1 flows, to calculate the actual working time, based on current values which are included in the sensor data SDA corresponding to IDA (refer to FIG. 2) and which are measured at measurement times included in the corresponding work date and time such as “2016, Feb. 3, 10:10 to 15:10”.

Likewise, the data processing unit 33 accumulates time periods, during which a current exceeding the threshold value Th1 flows, to calculate the actual working time, based on current values which are included in the sensor data SDB corresponding to IDB (refer to FIG. 3) and which have been measured at measurement times included in the corresponding work date and time such as “2016, Feb. 4, 08:00 to 11:40”.

The data processing unit 33 totals up the accumulated actual working time for each day, for example. In addition, the data processing unit 33 totals up the welding length regarding the task name MA for each day, based on the report data FA2, FB2, for example.

The data processing unit 33 calculates the welding length and the actual working time for each day, based on the respective totaled results, and writes the calculation results into a summary table SumA2 shown in FIG. 11.

For the task name MB, the data processing unit 33 performs the same process as that for the task name MA, and writes the calculation results of the welding length and the actual working time for each day into a summary table SumB2 (not shown).

The data processing unit 33 notifies the display control unit 34 of the contents of the summary tables SumA2, SumB2.

Although the data processing unit 33 is configured to total up the “welding length/actual working time” for each task name, based on the sensor data SDA, SDB, the correspondence information, and the report data FA2, FB2, the present disclosure is not limited thereto. The data processing unit 33 may use, as a management item, at least one of the type of the welding machine, the working posture such as horizontal posture or vertical posture, the operator's name, the name of a company undertaking the work, and the name of a company that has ordered the work, and may total up the “welding length/actual working time” for each management item.

For example, when the “welding length/actual working time” is totaled for each type of the welding machine, it is possible to know efficiency of each apparatus 3.

When the “welding length/actual working time” is totaled for each working posture, it is possible to evaluate propriety of the “welding length/actual working time”, based on the working posture, taking into account that difficulty of welding varies depending on the welding posture.

When the “welding length/actual working time” is totaled for each operator' name, it is possible to evaluate working efficiency of each operator.

When the “welding length/actual working time” is totaled for each company's name undertaking the work, it is possible to know working capability of each company undertaking the work.

When the “welding length/actual working time” is totaled for each company's name that has ordered the work, it is possible to know difficulty of the welding work for each ordering company.

### (Modification 2)

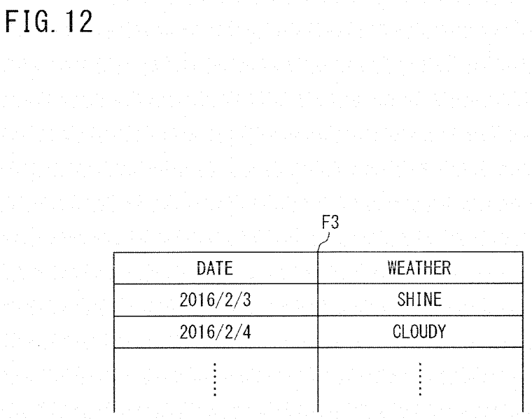

FIG. 12 illustrates an example of report data retained by the terminal device in the management system according to the first embodiment of the present disclosure.

With reference to FIG. 12, in this example, the terminal device 151 retains the report data FA2, FB2 shown in FIG. 9 and FIG. 10, and report data F3.

The report data F3 includes daily “weather”, for example. The report data F3 may include morning (A.M.) weather and afternoon (P.M.) weather, or may include hourly weather.

The operator 2 or the manager performs an operation of inputting daily weather through the terminal device 151.

Upon receiving the operation performed by the operator 2 or the manager, the terminal device 151 performs a process of writing the content of the operation into the report data F3.

Referring back to FIG. 6, when a predetermined condition C2 is satisfied, the data processing unit 33 transmits a report data request R3 for requesting the report data F3, to the terminal device 151 via the communication unit 31. The predetermined condition C2 is, for example, completion of a task for a project, or end of month.

The data processing unit 33 receives, as a response to the report data request R3, the report data F3 from the terminal device 151 via the communication unit 31.

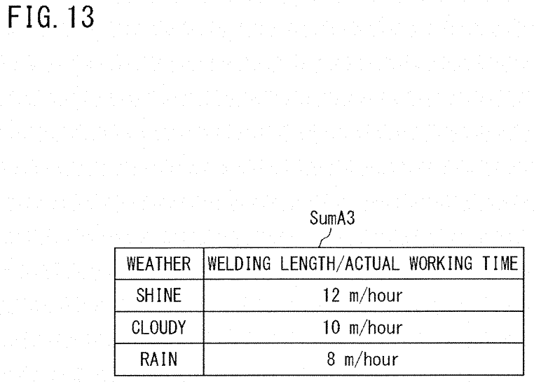

FIG. 13 illustrates an example of a summary table created by the management device according to the first embodiment of the present disclosure.

With reference to FIG. 13, the data processing unit 33 performs, for example, a process of aggregating the measurement information for each of the contents of the management item and for each of other pieces of information.

Specifically, the data processing unit 33 performs, for example, a process of totaling up the welding length and the actual working time for each task name and for each weather type, based on the summary table SumA2 shown in FIG. 11 and the report data F3.

More specifically, as for the task name MA, the data processing unit 33 acquires the correspondence of the welding length and the actual working time to the weather for each day, and totals up the acquisition result, thereby writing the welding length and the actual working time for each weather type into a summary table SumA3 shown in FIG. 13.

Also for the task name MB, the data processing unit 33 performs the same process as that for the task name MA, thereby writing the welding length and the actual working time for each weather type into a summary table SumB3 (not shown).

The data processing unit 33 notifies the display control unit 34 of the contents of the summary tables SumA3, SumB3.

For example, in a situation where the welding work is performed outdoors, since a work plan is established with the weather condition being checked, it is possible to establish an appropriate work plan based on the “welding length/actual working time” for each weather type.

### [Operation]

Each of the devices in the management system 301 is provided with a computer. An arithmetic processing unit such as a CPU in the computer reads out a program, which includes a part or the entirety of steps of a sequence chart or a flowchart described below, from a memory (not shown), and executes the program. The programs of the plurality of devices can be installed from the outside. The programs of the plurality of devices are distributed while being stored in a storage medium.

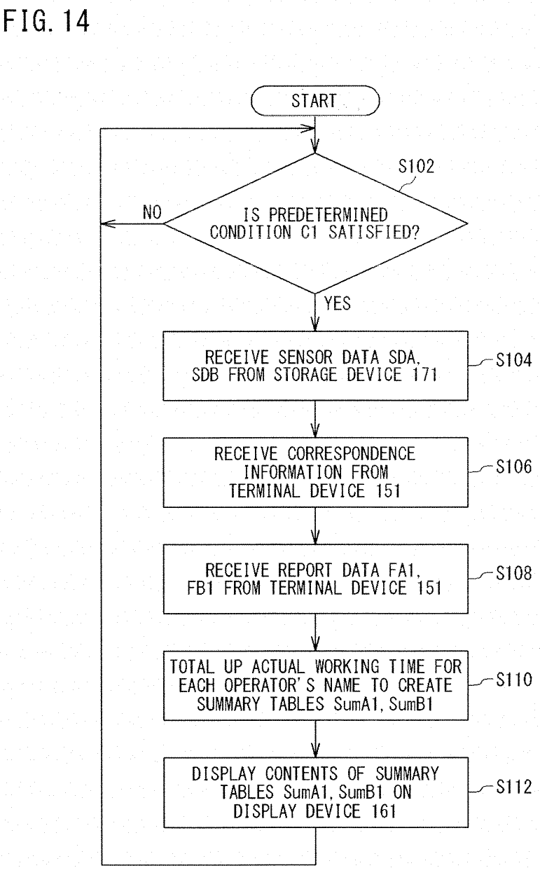

FIG. 14 is a flowchart showing an operation procedure when the management device according to the first embodiment of the present disclosure performs a process of aggregating the measurement information for each of the contents of the management item.

With reference to FIG. 14, the management device 101 stands by until the predetermined condition C1 is satisfied (NO in step S102). When the predetermined condition Cl has been satisfied (YES in step S102), the management device 101 transmits a sensor data request to the storage device 171, and receives, as a response to the sensor data request, the sensor data SDA, SDB from the storage device 171 (step S104).

Next, the management device 101 transmits a correspondence information request to the terminal device 151, and receives, as a response to the correspondence information request, the correspondence information from the terminal device 151 (step S106).

Next, the management device 101 recognizes that the report data corresponding to IDA, IDB are the report data FA1, FB1, respectively, based on the correspondence information. Then, the management device 101 transmits a report data request R1 to the terminal device 151, and receives, as a response to the report data request R1, the report data FA1, FB1 from the terminal device 151 (step S108).

Next, based on the sensor data SDA, SDB, the correspondence information, and the report data FA1, FB1, the management device 101 totals up the actual working time for each operator's name, and writes the totaled results into the summary tables SumA1, SumB1 (step S110).

Next, the management device 101 controls the display device 161 to display the contents of the summary tables SumA1, SumB1 (step S112).

Next, the management device 101 stands by until the predetermined condition C1 is satisfied (NO in step S102).

Steps S104 and S106 are not necessarily performed in the above order, and may be switched with each other.

Although the management system according to the first embodiment of the present disclosure includes a plurality of apparatuses 3 and a plurality of sensors 11, the present disclosure is not limited thereto. The management system 301 may include a single apparatus 3 and a single sensor 11. In this configuration, the management device 101 is capable of aggregating the measurement information based on the measurement result of the sensor 11 for each of the contents of the management item, without the necessity of acquiring the sensor ID corresponding to the measurement result of the sensor 11 and the sensor ID corresponding to the use period of the apparatus 3.

Although the communication unit 31 in the management device according to the first embodiment of the present disclosure is configured to use the time at which a measurement packet is received, as the measurement time corresponding to the measurement result of the sensor 11, the present disclosure is not limited thereto. In the management system 301, the sensor 11 may include, in a measurement packet, the measurement time at which measurement is performed, and may transmit the measurement packet to the management device 101, and the communication unit 31 in the management device 101 may use the measurement time included in the received packet.

Although the storage unit is provided in the terminal device 151 in the management system according to the first embodiment of the present disclosure, the present disclosure is not limited thereto. In the management system 301, the storage unit may be provided in the storage device 171 or may be provided in the management device 101. In addition, the storage unit may be a portable storage device such as a USB memory.

In the management device according to the first embodiment of the present disclosure, although the data processing unit 33 is configured to total up the actual working time for each operator's name and for each day, based on the sensor data SDA, SDB, the correspondence information, and the report data FA1, FB1, the present disclosure is not limited thereto. The data processing unit 33 may aggregate the actual working time for each operator's name, based on the aforementioned pieces of information.

In the management device according to the first embodiment of the present disclosure, although the data processing unit 33 is configured to aggregate the welding length and the actual working time for each of the contents of a single management item, in other words, for each task name, based on the sensor data SDA, SDB, the correspondence information, and the report data FA2, FB2, the present disclosure is not limited thereto. The data processing unit 33 may aggregate the welding length and the actual working time for each of the contents of a plurality of management items. Specifically, the data processing unit 33 may aggregate the welding length and the actual working time for each operator's name and for each task name, based on the aforementioned pieces of information and the report data FA1, FB1.

In the management device according to the first embodiment of the present disclosure, although the data processing unit 33 is configured to aggregate the welding length and the actual working time for each weather type and for each task name, the present disclosure is not limited thereto. The data processing unit 33 may aggregate the actual working time for each weather type and for each task name.

Incidentally, a system has been studied in which production data is collected through a recording device provided in an apparatus, and workloads of operators, production costs, etc., are calculated based on the collected production data, by using the welding system disclosed in Patent Literature 1, for example.

However, under a situation where an operator who handles the apparatus is replaced with another operator, or the production content of the apparatus is changed, it is difficult to calculate, based on the production data, workloads by operator and production costs by production content.

In contrast to the above system, in the management device according to the embodiment of the present disclosure, the communication unit 31 acquires the measurement result of the sensor 11 which performs measurement regarding the apparatus 3, and the time corresponding to the measurement result, and further acquires, from the storage unit, a plurality use periods of the apparatus 3, and the contents of the management item corresponding to the respective use periods. Then, the data processing unit 33 performs a process of aggregating the measurement information based on the measurement result, for each of the contents of the management item, on the basis of the measurement result and the corresponding time acquired by the communication unit 31, and the contents of the management item and the corresponding use periods.

According to this configuration, by using, for example, “operator 2” or “production content” as the content of the management item, even when an operator 2 handling the apparatus 3 is replaced with another operator 2, or the production content of the apparatus 3 is changed, it is possible to aggregate the working time based on the measurement result, for each operator 2 or for each production content. Thus, it is possible to easily calculate workloads by operator 2 and production costs by production content, for example. Consequently, it is possible to manage the apparatus through a simple process.

In the management device according to the embodiment of the present disclosure, the communication unit 31 further acquires the identification information of the sensor 11 corresponding to the measurement result, and further acquires, from the storage unit, the identification information of the sensor 11 corresponding to the use period. Then, the data processing unit 33 performs a process of aggregating the measurement information for each of the contents of the management item, further based on the respective pieces of identification information acquired by the communication unit 31.

According to this configuration, even when an operator 2 works at a plurality of apparatuses 3 or produces a work object 18 by using a plurality of apparatuses 3, since the measurement result and the corresponding time can be associated with the content of the management item and the corresponding use period, based on the respective pieces of identification information, it is possible to correctly calculate, for example, workloads by operator 2 and production costs by production content.

In the management device according to the embodiment of the present disclosure, a plurality of types of management items can be set.

According to this configuration, since the contents of the plurality of types of management items can be associated with each other, it is possible to precisely manage the apparatus 3.

In the management device according to the embodiment of the present disclosure, the data processing unit 33 performs the process of aggregating the measurement information for each of the contents of the management item and for each of other pieces of information.

According to this configuration, the processing result, which has been obtained by aggregating the measurement information for each of the contents of the management item, is further aggregated for each of other pieces of information. For example, when the measurement result correlates with weather, it is possible to precisely manage the apparatus 3 by adopting weather as the other piece of information.

In the management device according to the embodiment of the present disclosure, the display control unit 34 performs a control for displaying a result of the process performed by the data processing unit 33.

According to this configuration, a user of the management device 101 can recognize the processing result from the display content, and therefore can manage the apparatus more easily.

Next, another embodiment of the present disclosure will be described with reference to the drawings. In the drawings, the same or corresponding parts are denoted by the same reference numerals, and will not be repeatedly described.

### Second Embodiment

This embodiment relates to a management device which allows selection of a management item, in contrast to the management device of the first embodiment. The management device of the second embodiment is identical to the management device of the first embodiment except for matters described below.

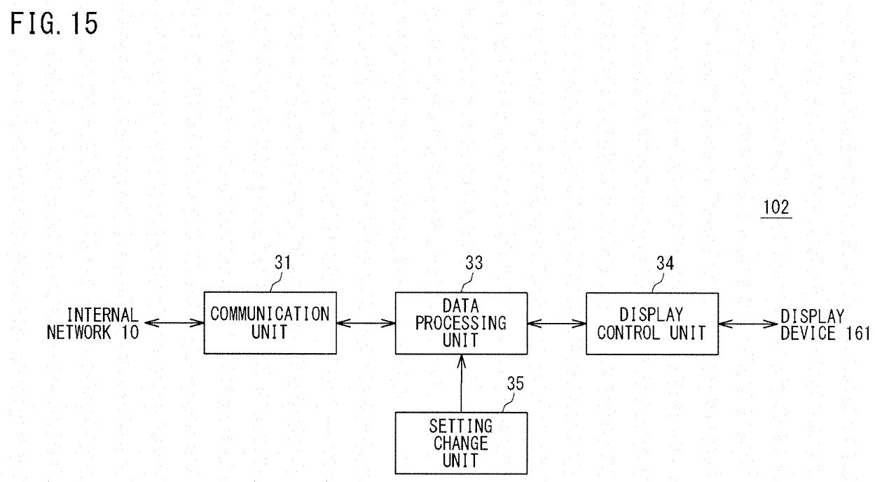

FIG. 15 illustrates the configuration of the management device according to the second embodiment of the present disclosure.

With reference to FIG. 15, the management device 102 includes a communication unit 31 (first acquisition unit and second acquisition unit), a data processing unit 33, a display control unit 34, and a setting change unit 35.

The operations of the communication unit 31, the data processing unit 33, and the display control unit 34 in the management device 102 are identical to the operations of the communication unit 31, the data processing unit 33, and the display control unit 34 in the management device 101 shown in FIG. 6, respectively.

The setting change unit 35 is capable of changing setting of the type of management item, for example. Specifically, the setting change unit 35 sets the content of the management item to either of “operator's name” or “task name and welding length”, in accordance with an operation performed by a user, for example. The setting change unit 35 notifies the data processing unit 33 of the setting content regarding the type of the management item.

The setting change unit 35 may be configured to be capable of adding a management item in accordance with an operation performed by the user.

The data processing unit 33 performs a process of totaling up the actual working time in accordance with the setting content notified from the setting change unit 35.

Specifically, when the setting content notified from the setting change unit 35 indicates “operator's name”, the data processing unit 33 totals up the actual working time for each operator's name, based on the sensor data SDA, SDB (refer to FIG. 2, FIG. 3), the correspondence information, and the report data FA1, FB1 (refer to FIG. 4, FIG. 5), and writes the totaled results into the summary table SumA1, SumB1 (refer to FIG. 7, FIG. 8).

When the setting content notified from the setting change unit 35 indicates “task name and welding length”, the data processing unit 33 totals up the welding length/actual working time for each operator's name, based on the sensor data SDA, SDB (refer to FIG. 2, FIG. 3), the correspondence information, and the report data FA2, FB2 (refer to FIG. 9, FIG. 10), and writes the totaled results into the summary tables SumA2 (refer to FIG. 11), SumB2.

For example, in a factory, a person in charge of labor management desires to know the actual working time for each operator's name in order to grasp efficiency of each operator, while a person in charge of cost management desires to know the welding length/actual working time for each task name in order to grasp efficiency of each task. Thus, the management target varies from user to user.

In the management device 102, settings of the type of the management item can be changed.

In this configuration, for example, even when a plurality of managers set different types of management items as management targets, a single management device can perform processes that satisfy the requirements of the respective managers, whereby the management device can be operated with high efficiency.

Since other components and operations according to the second embodiment are identical to those of the management device according to the first embodiment, detailed description thereof need not be repeated.

Some or all of the components and operations of the devices according to the first and second embodiments of the present disclosure may be combined as desired.

Note that the embodiments disclosed above are to be considered in all respects as illustrative and not restrictive. The scope of the invention is indicated by the appended claims rather than by the foregoing meaning, and all changes which come within the meaning and range of equivalency of the claims are therefore intended to be embraced therein.

The above description includes the features in the additional notes below.

### [Additional Note 1]

A management device comprising:

a first acquisition unit configured to acquire a measurement result of a sensor which performs measurement regarding an apparatus, and a time corresponding to the measurement result;

a second acquisition unit configured to acquire, from a storage unit, a plurality of use periods of the apparatus, and contents of a management item corresponding to the respective use periods; and

a data processing unit configured to perform a process of aggregating, for each of the contents, measurement information based on the measurement result, on the basis of the measurement result and the corresponding time acquired by the first acquisition unit, and on the contents and the corresponding use periods obtained by the second acquisition unit, wherein

the apparatus is an electric welding machine,

the time is a time at which the first acquisition unit acquires the measurement result, or a time at which the sensor performs measurement on the apparatus,

the use periods and the contents are stored in the storage unit by a user, and

the data processing unit performs, based on the measurement result and the corresponding time and on the contents and the corresponding use periods, a process of calculating an actual use time of the apparatus, and aggregating the calculated actual use time for each of the contents.

### REFERENCE SIGNS LIST

2 operator

3 apparatus

10 internal network

11 sensor

12 distribution board

13A, 13B breaker

14 power line

15 output line

16 earth wire

17 torch

18 work object

31 communication unit (first acquisition unit and second acquisition unit)

33 data processing unit

34 display control unit

35 setting change unit

101, 102 management device

111 access point

151 terminal device (storage unit)

161 display device

171 storage device

301 management system

1. A management device comprising:
a first acquisition unit configured to acquire a measurement result of a sensor which performs measurement regarding an apparatus, and a time corresponding to the measurement result;
a second acquisition unit configured to acquire, from a storage unit, a plurality of use periods of the apparatus, and contents of a management item corresponding to the respective use periods; and
a data processing unit configured to perform a process of aggregating classifying, for each of the contents, measurement information based on the measurement result, on the basis of the measurement result and the corresponding time acquired by the first acquisition unit and the contents and the corresponding use periods acquired by the second acquisition unit.

2. The management device according to claim 1, wherein
the first acquisition unit further acquires first identification information which is identification information of the sensor corresponding to the measurement result,
the second acquisition unit further acquires, from the storage unit, second identification information which is identification information of the sensor corresponding to the use periods, and
the data processing unit performs the process of classifying the measurement information for each of the contents, further based on the first identification information acquired by the first acquisition unit and the second identification information acquired by the second acquisition unit.

3. The management device according to claim 1, wherein settings of the type of the management item are changeable.

4. The management device according to claim 1, wherein a plurality of types of management items are settable.

5. The management device according to claim 1, wherein the data processing unit performs a process of classifying the measurement information for each of the contents and for each of other pieces of information.

6. The management device according to claim 1, further comprising a display control unit configured to perform a control for displaying a result of the process performed by the data processing unit.

7. A non-transitory computer readable storage medium storing a computer program used in a management device, the computer program causing a computer to function as:
a first acquisition unit configured to acquire a measurement result of a sensor which performs measurement regarding an apparatus, and a time corresponding to the measurement result;
a second acquisition unit configured to acquire, from a storage unit, a plurality of use periods of the apparatus, and contents of a management item corresponding to the respective use periods; and
a data processing unit configured to perform a process of classifying, for each of the contents, measurement information based on the measurement result, on the basis of the measurement result and the corresponding time acquired by the first acquisition unit, and the contents and the corresponding use periods acquired by the second acquisition unit.

8. (canceled)
